(19) United States
(12) Patent Application Publication
(10) Pub. No.: US 2015/0234468 A1
(43) Pub. Date: Aug. 20, 2015

(54) Hover Interactions Across Interconnected Devices

(71) Applicant: Microsoft Corporation, Redmond, WA (US)

(72) Inventors: Dan Hwang, Renton, WA (US); Lynn Dai, Samamish, WA (US)

(73) Assignee: Microsoft Corporation, Redmond, WA (US)

(21) Appl. No.: 14/183,742

(22) Filed: Feb. 19, 2014

(51) Int. Cl. G06F 3/01; G06F 3/0481; G06F 3/0484

(52) U.S. Cl. CPC G06F 3/017; G06F 3/04842; G06F 3/04817

(57) ABSTRACT

Example apparatus and methods support interactions between a hover-sensitive apparatus and other apparatus. A hover action performed in the hover space of one apparatus can control that apparatus or another apparatus. The interactions may depend on the positions of the apparatus. For example, a user may virtually pick up an item on a first hover-sensitive apparatus and virtually toss it to another apparatus using a hover gesture. A directional gesture may selectively send content to a target apparatus while a directionless gesture may send content to a distribution list or to any apparatus in range. A shared display may be produced for multiple interconnected devices and coordinated information may be presented on the shared display. For example, a chessboard that spans two smartphones may be displayed and a hover gesture may virtually lift a chess piece from one of the displays and deposit it on another of the displays.

### BACKGROUND

As handheld devices like smartphones and tablets become even more ubiquitous, interactions between these every day devices will become more common. Not only will more and more devices and peripherals be able to connect to each other, but the sophistication and richness of the interactions will continue to improve. For example, users may be able to transfer images or songs using “bump” technology, which may be referred to as near field communication (NFC). Conventionally, these interactions have been controlled by inward focused actions based on the concept of “my” device in my space and “your” device in your space. Thus, while devices interact with each other, users tend to interact with their own device in their own space.

Users may be familiar with connecting their smartphone to a larger display and having the larger display present information from the smartphone. While the smartphone may rely on a peripheral like a big screen to improve a presentation experience, the smartphone is still considered “my” device, and the peripheral (e.g., large screen) is simply allowing others to experience what is happening in my space. While the devices may be interacting, the devices are not collaborating to the extent that may be possible using different techniques.

Conventional devices may have employed touch or even hover technology for interactions with a user. However, conventional systems have considered the touch or hover interactions to be within a current context where all interactions by a user are happening on-screen on their own device, even if their device is relying on a peripheral like a big screen.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed toward allowing a user to interact with two or more devices at the same time using hover gestures on one or more of the devices. Example apparatus and methods may extend the range of hover interactions performed on one device to other devices. Different gestures may be used for different interactions. For example, an item may be picked up on a first device using a hover gesture (e.g., crane lift) and then the item may be provided to another interconnected device using a hover gesture (e.g., toss) that is directed toward the other device. In one embodiment, an item may be picked up on a first hover-sensitive device and distributed to a plurality of other interconnected devices using a directionless hover gesture (e g., poof). When other interconnected devices are hover-aware, a shared or interacting hover space may be created. The shared hover space allows two devices to create and interact with a shared hover space. For example, when playing checkers, if two hover-sensitive devices are positioned together, then the smaller game screens on each of the two devices may be morphed into a single larger screen that may be shared between the two devices. A hover gesture that begins on a first device may be completed on a second device. For example, a hover gesture (e.g., crane lift) may be used to pick up a checker on a first portion of the shared screen and then another hover gesture (e.g., crane drop) may be used to drop the checker on a second portion of the shared screen.

Some embodiments may include a capacitive input/output (i/o) interface that is sensitive to hover actions. The capacitive i/o interface may detect objects (e.g., finger, thumb, stylus) that are not touching the screen but that are located in a three dimensional volume (e.g., hover space) associated with the screen. The capacitive i/o interface may be able to detect multiple simultaneous hover actions. A first hover-sensitive device (e.g., smartphone) may establish a context that will control how the first device will interact with a second interconnected device (e.g., smartphone, tablet). The context may be direction dependent or direction independent. Hover interactions with the first device may then produce results on the first and/or the second device. The capacitive i/o interface associated with a first device may detect hover actions in a three dimensional volume (e.g., hover space) associated with the first device. The capacitive i/o interface associated with a second device may detect hover actions in a hover space associated with the second device. The two devices may communicate and share information about the hover actions in their respective hover spaces to simulate the creation of a shared hover space. The shared hover space may support interactions that span devices.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example hover-sensitive device.

FIG. 2 illustrates a hover gesture being used to move content from a first device to other devices.

FIG. 3 illustrates two hover-sensitive devices being used to play checkers.

FIG. 4 illustrates two hover-sensitive devices being used to play checkers using a combined hover space.

FIG. 5 illustrates an example method associated with hover interactions across interconnected devices.

FIG. 6 illustrates an example method associated with hover interactions across interconnected devices.

FIG. 7 illustrates an example cloud operating environment in which a hover-sensitive device may use hover interactions across interconnected devices.

FIG. 8 is a system diagram depicting an exemplary mobile communication device having a hover-sensitive interface that may use hover interactions across interconnected devices.

FIG. 9 illustrates an example apparatus that facilitates processing hover interactions across interconnected devices.

FIG. 10 illustrates hover-sensitive devices using a shared hover-space to support hover interactions that span interconnected devices.

FIG. 11 illustrates a time sequence where two devices come together to create a larger shared display on which a hover action can span devices.

### DETAILED DESCRIPTION

As devices like phones and tablets become even more ubiquitous, the uses to which a user's “phone” is put have increased dramatically. For example, users play games on their phones, surf the web on their phones, handle emails on their phones, and perform other actions. Users may use productivity applications (e.g., word processing, spreadsheets) on their tablets. However, conventional devices tend to focus on the individual context, where I do work on “my” phone and interact with you on “your” phone. Thus, interactions on a first device are generally viewed from the perspective of controlling that first device. Some hover gestures (e.g., crane, toss, poof) facilitate expanding a user's horizon to other devices.

A poof gesture may be performed using three or more fingers that were pinched together. The three fingers may be spread more than a threshold distance apart at more than a threshold rate in at least three different directions. A flick gesture may be performed by moving a single finger more than a threshold distance at more than a threshold rate in a single direction. A hover crane gesture may be performed by pinching two fingers together over an object to “grab” the object, moving the two fingers away from the interface to “lift” the object, and then while the two fingers are still pinched, moving the two fingers to another location. The hover crane gesture may end when the user spreads their two fingers to “drop” the item that had been grabbed, lifted, and transported.

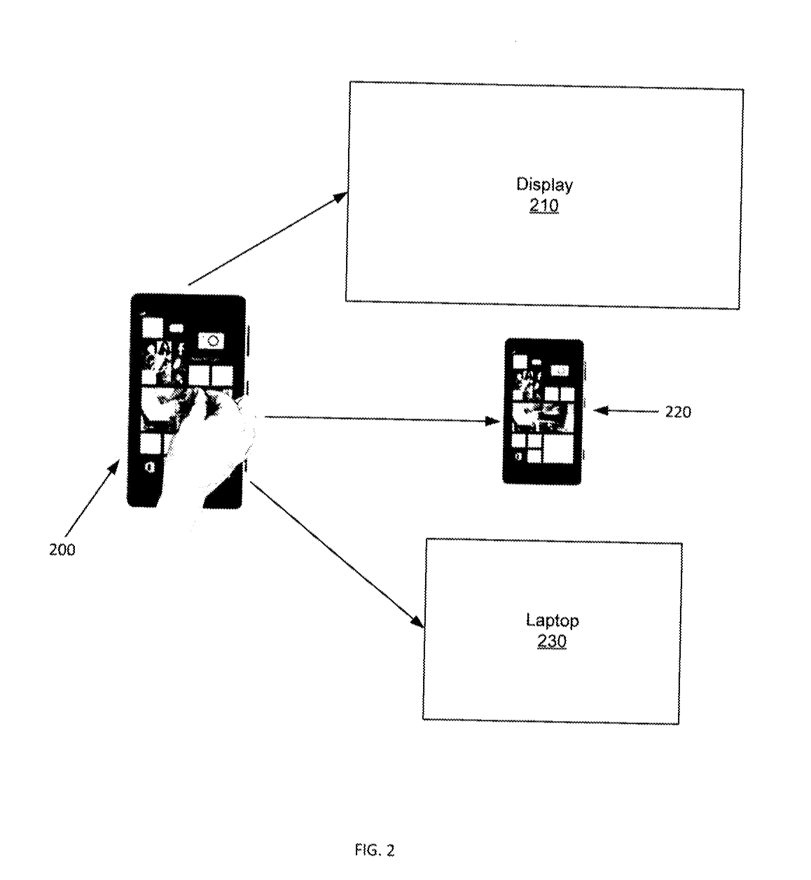

Example apparatus and methods use hover gestures to interact with connected phones, tablets, displays, peripherals, and other devices. FIG. 2 illustrates a phone 200 that is hover-sensitive sharing data with a large display 210, another phone 220, and a tablet 230 being used in laptop mode. The connected devices may be located nearby and may communicate using, for example, NFC, Bluetooth, WiFi, HDMI, or other connection techniques. A user may virtually pick up an image on their smartphone (e.g., phone 200) using a hover crane gesture and then ‘toss’ the lifted object to a nearby device(s) (e.g., phone 220) using a combined hover crane release and toss gesture. Rather than sending an email or text, or dropping the image on an icon that represents an application on their smart phone, all of which are inwardly directed actions, the user may “toss” the image by making a hover gesture above their device. The toss gesture may be more outwardly directed, which may change the interaction experience for users. This type of hover gesture may be used, for example, to move or copy content from one device to another device or groups of devices. The toss gesture may rely on a concept of a direction between devices to send content to a specific nearby device. While a toss gesture may be “directional”, a “poof” gesture may be a directionless gesture that may move or copy content from one device (e.g., phone 200) to a group of devices (e.g., display 210, phone 220, tablet 230). In one embodiment, the devices may need to be in range of a short range wireless connection. In another embodiment, the poof gesture may distribute content to receivers in a distribution list.

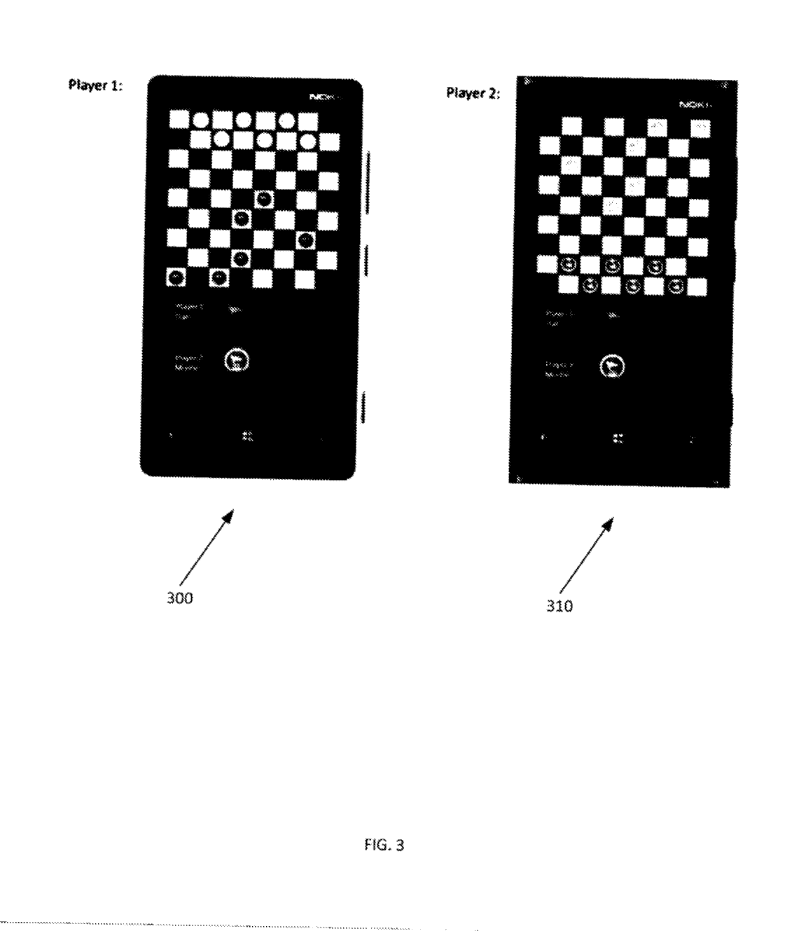

Example apparatus and methods may use hover gestures to interact with non-hover-sensitive devices or other hover-capable phones, tablets, displays, or other devices. In one embodiment, a shared hover session may be established between co-operating devices. When the shared hover session is established, a hover gesture may begin (e.g., hover crane lift) above a first device and be completed (e.g., hover crane release) above a second device. Consider a game of checkers being played by two friends. FIG. 3 illustrates a phone 300 being used by a first player and a phone 310 being used by a second player. Conventionally, each friend may have their own display of the complete checkerboard. Phone 300 shows the entire checkerboard from the point of view of player 1, whose pieces may be a first color (e.g., blue). Phone 310 shows the entire checkerboard from the point of view of player 2, whose pieces may be a second color (e.g., red). When one friend moves a piece, the piece moves on their phone and also moves on their friend's phone. On the friend's phone, the piece just appears to move, there is no connection to an action by the other friend. The two friends are watching two separate checkerboards and having two separate experiences even though technically they are playing together.

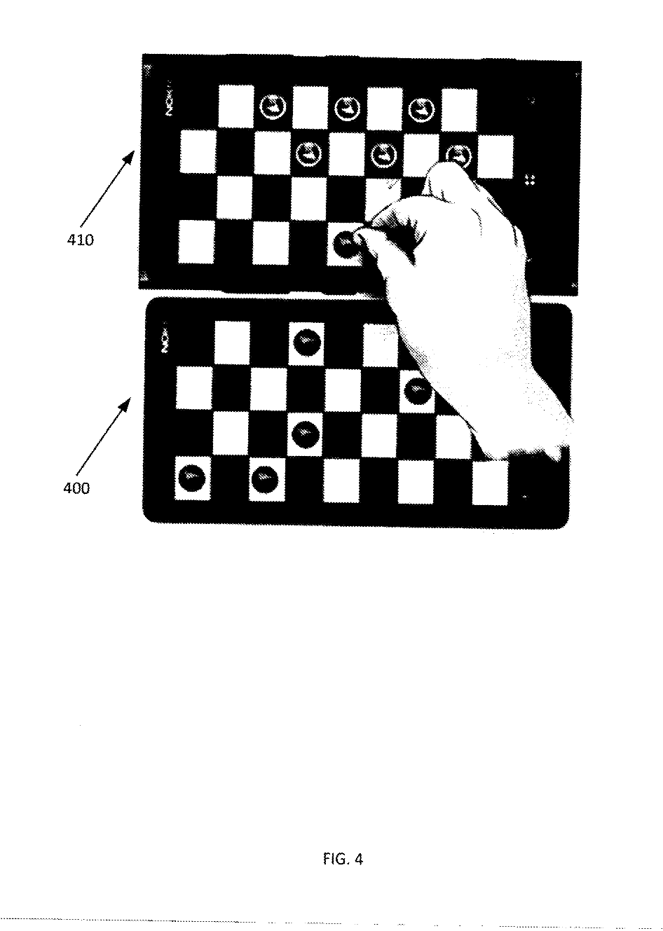

Now imagine that the two friends are sitting together over coffee. If the two friends push their phones together, then the smaller game screens on each of the two phones may be morphed into a single larger screen that is shared between the two phones. FIG. 4 illustrates two phones that have been pushed together. Unlike phone 300 and phone 310 in FIG. 3 that each showed their own complete checkerboard, phones 400 and 410 each show half of a larger checkerboard. The two friends are now playing together on their larger shared display in a hover session that spans the connected device. Different hover gestures may be possible when the devices have a shared display and a shared hover session.

For example, a hover gesture that begins on a first device (e.g., phone 400) may be completed on a second device (e.g., phone 410). One friend may use a hover gesture (e.g., crane lift) to pick up a checker on a first portion of the shared screen (e.g., over phone 400) and then complete the hover gesture (e.g., crane drop) by placing the checker on a second portion (e.g., over phone 410) of the shared screen. Rather than two friends spending their time looking at their own small screens and moving pieces on their own small screens, the two friends spend their time looking at their larger, shared screen and moving pieces on the larger, shared screen. The moves of an opponent are no longer just revealed by the movement of the pieces on the screen, but the moves are connected to the physical actions in the shared hover space. While FIG. 4 shows two phones being pushed together to create a shared display that may be controlled by actions that span the hover spaces from phone 400 and phone 410, in different embodiments, more than two phones may be positioned to create a shared display. Additionally, devices other than phones (e.g., tablets) may be positioned to create a shared display. For example, four co-workers may position their tablets together to create a large shared display that uses the combined hover spaces from the four devices. In one embodiment, different types of devices may be positioned together. For example, a phone and a tablet may be positioned together. Consider a scenario where two friends decide to play football. Each friend may have their own playbook and their own customized controls in their smartphone. One friend may also have a tablet computer. The friends may position their phones near the tablet and use hover gestures to select plays and move players. The tablet may provide a shared display where the results of their actions are played out. This may fundamentally change game play from an individual introspective perspective to a mutual outward-looking shared perspective.

Users may be familiar with dragging and dropping items on their own devices. Users may even be familiar with dragging and dropping items on a large display that others can see. This drag and drop experience is inwardly focused and generally requires that an object be accurately deposited on top of a target. For example, a user may drag an image to a printer icon, to a trash icon, to a social media icon, or to another icon, to signal their intent to send that content to that application or to have an action performed for that content. Example apparatus and methods facilitate a new outward-directed functionality where a user may pick up an object and copy, move, share, or otherwise distribute the object to an interconnected device with which the user's device has established a relationship. The target of the outward gesture may not need to be as precisely accessed as a conventional drag and drop operation. For example, if there are just two other devices with which a user is interacting, one on the user's left and one on the user's right, then a hover gesture that tosses content to the left will be sent to the device on the left, a hover gesture that tosses content to the right will be sent to the device on the right, and a hover gesture that encompasses both left and right (e.g., hover poof) may send the content to both devices. In one embodiment, the position of a device may be tracked and a gesture may need to be directed toward the device's current position. In another embodiment, once a relationship is established between devices, a hover gesture that depends on the position of an interconnected device may send content to that device even after that device moves out of its initial position.

Hover interactions that span devices may facilitate new work patterns. Consider a user that has arrived back home after a day spent using their phone. The user may have taken some photographs, may have made some voice memos, and may have received some emails. The user may sit down at their desk where they have various devices positioned. For example, the user may have a printer on the left side of their desk, may have their desktop system on the right side of the desk, and may have their laptop positioned at the back of the desk. The user may have an image viewer running on their laptop and may have a word processor running on their desktop system. The user may position their phone in the middle of the desk and start tossing content to the appropriate devices. For example, the user may toss photos to the device housing the image viewer, may toss voice memos to the device housing the word processing application, and may send some emails and images to the printer. In one embodiment, when the photo is tossed to the device housing the image viewer, if the image viewer is not currently active, then the image viewing application may be started. Thus, the user's organizational load is reduced because hover gestures can be used to move content from the hover sensitive device to other devices rather than having to drag and drop content on their screen. In one embodiment, the user may be able to use the hover gestures for distributing their content to their devices even when the devices have been moved or even when the user is not “in range” of the devices. For example, a user may know that hover tosses to the left will eventually reach the printer, that hover tosses to the back will eventually reach the image viewer, and that hover tosses to the right will eventually reach the word processing application since those relationships were previously established and have not been dismissed. Since the relationships have been established, there may be no need to display icons like a printer or trash can on a hover-sensitive device, which may save precious real estate on smaller screens like those found in smartphones, In one embodiment, a user may decide to “recall” an item that was tossed but not yet delivered.

Hover technology is used to detect an object in a hover space. “Hover technology” and “hover-sensitive” refer to sensing an object spaced away from (e.g., not touching) yet in close proximity to a display in an electronic device. “Close proximity” may mean, for example, beyond 1 mm but within 1 cm, beyond 0.1 mm but within 10 cm, or other combinations of ranges. Being in close proximity includes being within a range where a proximity detector (e.g., capacitive sensor) can detect and characterize an object in the hover space. The device may be, for example, a phone, a tablet computer, a computer, or other device/accessory. Hover technology may depend on a proximity detector(s) associated with the device that is hover-sensitive. Example apparatus may include the proximity detector(s).

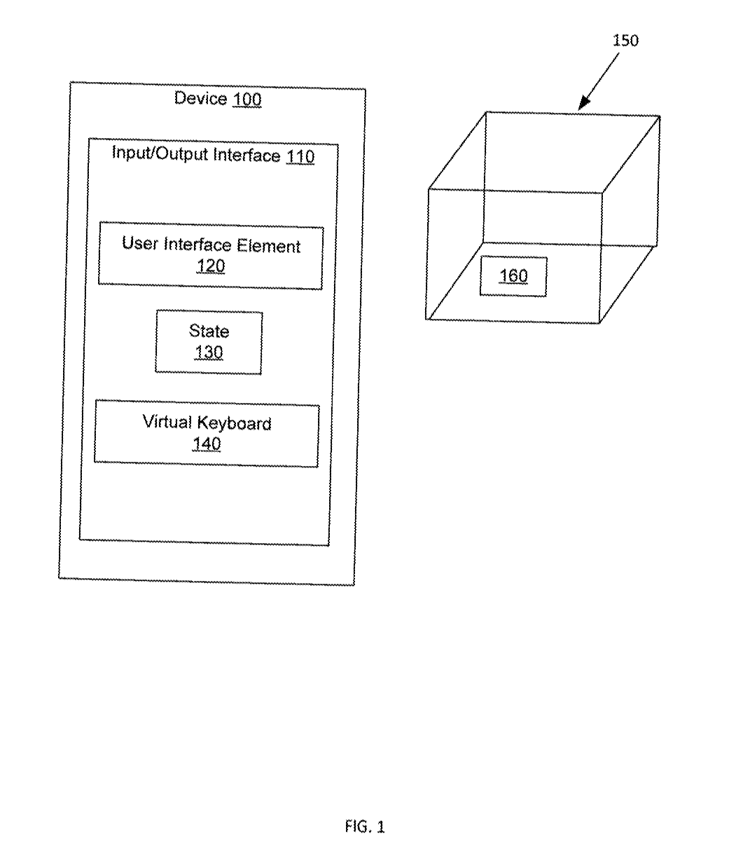

FIG. 1 illustrates an example device 100 that is hover-sensitive. Device 100 includes an input/output (i/o) interface 110. I/O interface 110 is hover-sensitive. I/O interface 110 may display a set of items including, for example, a virtual keyboard 140 and, more generically, a user interface element 120. User interface elements may be used to display information and to receive user interactions. Conventionally, user interactions were performed either by touching the i/o interface 110 or by hovering in the hover space 150. Example apparatus facilitate identifying and responding to input actions that use hover actions.

Device 100 or i/o interface 110 may store state 130 about the user interface element 120, a virtual keyboard 140, other devices to which device 100 is in data communication with or operably connected to, or other items. The state 130 of the user interface element 120 may depend on the order in which hover actions occur, the number of hover actions, whether the hover actions are static or dynamic, whether the hover actions describe a gesture, or on other properties of the hover actions. The state 130 may include, for example, the location of a hover action, a gesture associated with the hover action, or other information.

The device 100 may include a proximity detector that detects when an object (e.g., digit, pencil, stylus with capacitive tip) is close to but not touching the i/o interface 110. The proximity detector may identify the location (x, y, z) of an object 160 in the three-dimensional hover space 150, where x and y are orthogonal to each other and in a plane parallel to the surface of the interface 110, and z is perpendicular to the surface of interface 110. The proximity detector may also identify other attributes of the object 160 including, for example, the speed with which the object 160 is moving in the hover space 150, the orientation (e.g., pitch, roll, yaw) of the object 160 with respect to the hover space 150, the direction in which the object 160 is moving with respect to the hover space 150 or device 100, a gesture being made by the object 160, or other attributes of the object 160. While a single object 160 is illustrated, the proximity detector may detect more than one object in the hover space 150.

In different examples, the proximity detector may use active or passive systems. In one embodiment, a single apparatus may perform the proximity detector functions. The detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the detector uses capacitive technology, the detector may include a set of capacitive sensing nodes to detect a capacitance change in the hover space 150 or on the i/o interface 110. The capacitance change may be caused, for example, by a digit(s) (e.g., finger, thumb) or other object(s) (e.g., pen, capacitive stylus) that come within the detection range of the capacitive sensing nodes.

In general, a proximity detector includes a set of proximity sensors that generate a set of sensing fields in the hover space 150 associated with the i/o interface 110. The proximity detector generates a signal when an object is detected in the hover space 150. The proximity detector may characterize a hover action. Characterizing a hover action may include receiving a signal from a hover detection system (e.g., hover detector) provided by the device. The hover detection system may be an active detection system (e.g., infrared, ultrasonic), a passive detection system (e.g., capacitive), or a combination of systems. The signal may be, for example, a voltage, a current, an interrupt, a computer signal, an electronic signal, or other tangible signal through which a detector can provide information about an event the detector detected. In one embodiment, the hover detection system may be incorporated into the device or provided by the device.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

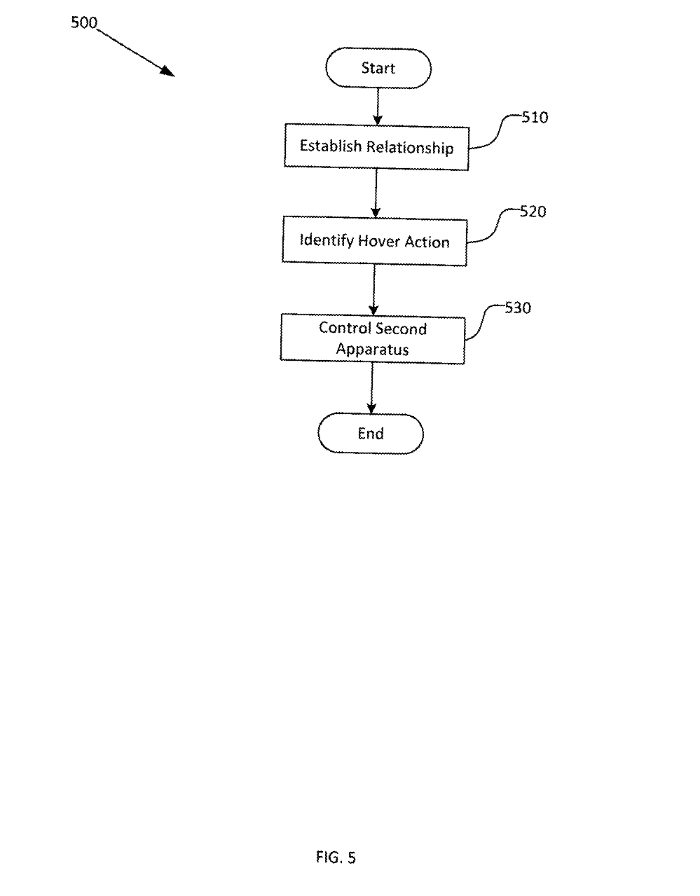

FIG. 5 illustrates an example method 500 associated with hover interactions that may span interconnected devices. Method 500 may be used to control a first device (e.g., phone, tablet, computer) having a hover-sensitive interface. Method 500 may also be used to control a second device (e.g., phone, tablet, computer) based on hover actions performed at the first device. The second device may be a hover-sensitive device or may not be a hover-sensitive device.

Method 500 includes, at 510, controlling the first device to establish a relationship between the first device and the second device. The relationship may control how actions performed at the first device will be used to control the first device and one or more second devices. The relationship may be a directionless relationship or may be a directional relationship. A directional relationship depends on information about the relative or absolute positions of the first device and the second device. The directional relationship may record, for example, that the first device is located to the right of the second device and the second device is located to the left of the first device. The directional relationship may record, for example, that the second device is located at a certain angle from the midpoint of a line that connects the bottom of the first device to the top of the first device through the center of the first device. Establishing the relationship at 510 may include, for example, establishing a wired link or a wireless link. The wired link may be established using, for example, an HDMI (high definition multimedia interface) interface, a USB (universal serial bus) interface, or other interface. The wireless link may be established using, for example, a Miracast interface, a Bluetooth interface, an NFC (near field communication) interface, or other interface. A Miracast interface facilitates establishing a peer-to-peer wireless screen-casting connection using WiFi direct connections. A Bluetooth interface facilitates exchanging data over short distances using short-wavelength microwave transmission in the ISM (Industrial, Scientific, Medical) band. Establishing the relationship at 510 may also include managing user expectations. For example, just because a hover-sensitive device is in range doesn't mean that a user ought to be able to toss any and all content to that device. Some users may prefer to not receive any shared content, or may prefer to only receive content from some specific users. Therefore, establishing the relationship at 510 may include determining what content, if any, may be shared. The decision about which content may be shared may be based, for example, on file size, data rates, bandwidth, user identity, or other factors.

Method 500 may also include, at 520, identifying a hover action performed in the first hover space. The hover action may be, for example, a hover crane gesture, a hover enter action, a hover leave action, a hover move action, a hover flick action, or other action. A flick gesture may be performed by moving a single finger more than a threshold distance at more than a threshold rate in a single direction. A hover crane gesture may be performed by pinching two fingers together over an object to “grab” the object, moving the two fingers away from the interface to “lift” the object, then while the two fingers are still pinched, moving the two fingers to another location. The hover crane gesture may end when the user spreads their two fingers to “drop” the item that had been grabbed, lifted, and transported.

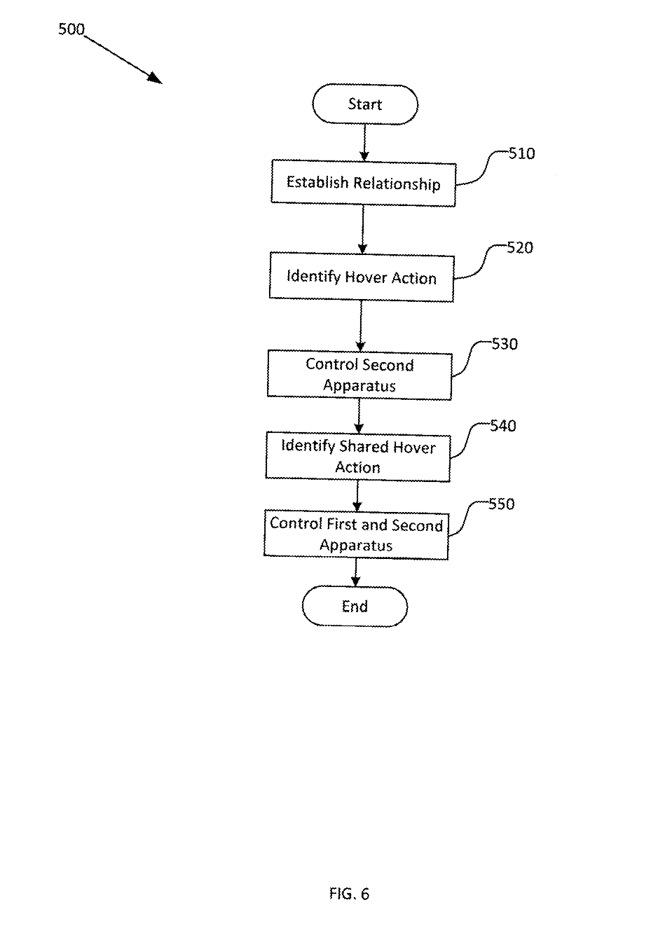

Method 500 may also include, at 530, controlling the second apparatus based, at least in part, on the hover action. In one embodiment, the hover action may begin and end in the first hover space. In another embodiment, described in connection with FIG. 6, the hover action may begin in the first hover space and end in another hover space. Since hover actions may be performed at or near the same time on multiple devices, in one embodiment, a shared hover space session may be maintained in the first device. The shared hover space may facilitate handling situations where, for example, a user has started a first action over a first device that will end over a second device and, during the first action, another user starts a second action over the second device. For example, during a checkers game, a first user may pick up a checker on one device and may intend to drop it on the second device, but while in motion a second user may do something on the second device. Thus, in one embodiment, establishing the relationship at 510 may include determining where to maintain a context for coordinating hover actions.

Controlling the second apparatus at 530 may include starting, waking up, instantiating, or other otherwise controlling a thread, process, or application on the second apparatus based on the hover action. For example, if the hover action provided a link, then controlling the second apparatus at 530 may include providing the link to the second apparatus and also causing an application (e.g., web browser) that can process the link to handle the link. Thus, providing the link may cause a web browser to be started and then may cause the web browser to navigate as controlled by the link.

In one embodiment, establishing the relationship at 510 includes identifying relative or absolute geographic positions for the first apparatus and the second apparatus and storing data describing the relative or absolute geographic positions. In this embodiment, controlling the second apparatus at 530 depends, at least in part, on the data describing the relative or absolute geographic positions. The data may be, for example, Cartesian coordinates in a three dimensional space, polar coordinates in a space centered on the first apparatus, or other device locating information. A hover crane gesture that picks up an object on the first apparatus may be identified at 520 and then may be followed by a hover toss gesture that is identified at 520. The hover toss gesture may be aimed in a specific direction. If the specific direction is within a threshold of the direction associated with the second apparatus, then controlling the second apparatus at 530 may include providing (e.g., copying, moving, sharing) the item picked up by the hover crane gesture to the second apparatus.

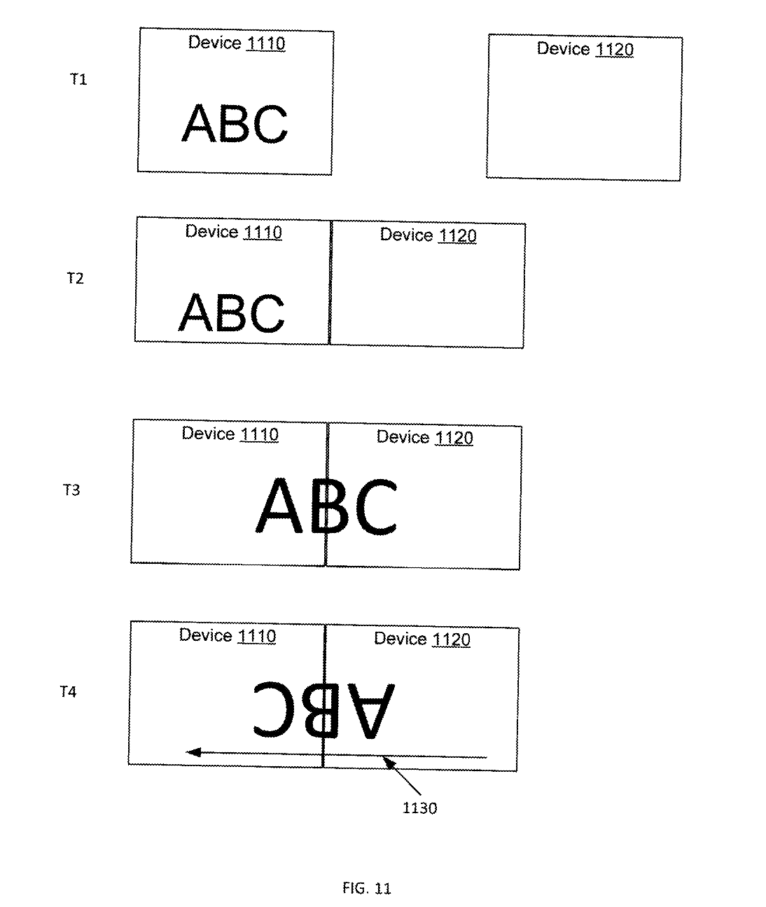

In one embodiment, establishing the relationship at 510 includes establishing a shared display between the first apparatus and the second apparatus. Establishing the shared display may involve making a larger display from two smaller displays as illustrated in FIG. 4 and FIG. 11. In this embodiment, controlling the second apparatus at 530 includes coordinating the presentation of information on the shared display. For example, a checker may be picked up on the first apparatus using a hover crane lift gesture identified at 520, virtually carried to the second apparatus using a hover crane move gesture identified at 520, and then virtually dropped on the second apparatus using a hover crane release gesture identified at 520. The display of the first apparatus may be updated to remove the checker from its former position and the display of the second apparatus may be updated to place the checker in its new position.

In one embodiment, the hover action identified at 520 may be a directionless gesture (e.g., pool). In this embodiment, controlling the second apparatus at 530 may include providing (e.g., copying, moving, allowing access) content from the first apparatus to the second apparatus and to other apparatus. The content that is provided may be selected, at least in part, by a predecessor (e.g. hover crane) to the directionless gesture. For example, an item may be lifted from the first apparatus using a hover crane gesture and then distributed to multiple other devices using a hover poof gesture.

In one embodiment, identifying the hover action at 520 may include identifying a direction associated with the action. For example, the hover action may be a flick or toss gesture that is aimed in a certain direction. In this embodiment, controlling the second apparatus at 530 may depend, at least in part, on the associated direction and the relative or absolute geographic positions. For example, in a shuffleboard game where two users have pushed their tablet computers together, a flick on a first tablet may send a shuffleboard piece towards the second tablet where the piece may crash into other pieces.

FIG. 6 illustrates another embodiment of method 500. This embodiment includes additional actions. For example, this embodiment includes handling hover events associated with a hover space in a second apparatus. In this embodiment, the second apparatus may be a hover-sensitive apparatus having a second hover space provided by the second apparatus. In this embodiment, establishing the relationship at 510 may include establishing a shared hover space for the first apparatus and the second apparatus. The shared hover space may include a portion of the first hover space and a portion of the second hover space.

In this embodiment, method 500 may include, at 540, identifying a shared hover action performed in the first hover space or in the second hover space. The shared hover action may be, for example, a content moving action (e.g., pick up image over first apparatus and release image over second apparatus), may be a game piece moving action (e.g., pick up checker on first apparatus and release over second apparatus), may be a propelling action (e.g., roll bowling ball from one end of a bowling lane displayed on a first apparatus toward where the pins are located at the other end of the bowling lane displayed on a second apparatus), or other action.

Method 500 may also include, at 550, controlling the first apparatus and the second apparatus based, at least in part, on the shared hover action. In this embodiment, the hover action may begin in the first hover space and end in the second hover space. In one embodiment, method 500 may control the first apparatus and second apparatus at 550 based, at least in part, on how long a shared hover action is taking. Thus, controlling the first apparatus and second apparatus at 550 may include terminating a shared hover action if the shared hover action is not completed within a threshold period of time. For example, if a first user picks up a chess piece in a first hover space and begins moving it toward a second hover space, the first user may have a finite period of time defined by, for example, a user-configurable threshold, in which the hover action is to be completed. If the first user does not put the chess piece down within the threshold period of time, then the hover action may be cancelled.

While FIGS. 5 and 6 illustrate various actions occurring in serial, it is to be appreciated that various actions illustrated in FIGS. 5 and 6 could occur substantially in parallel. By way of illustration, a first process could establish relationships between devices, a second process could manage shared resources (e.g., screen, hover space), and a third process could generate control actions based on hover actions. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 500 or 600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

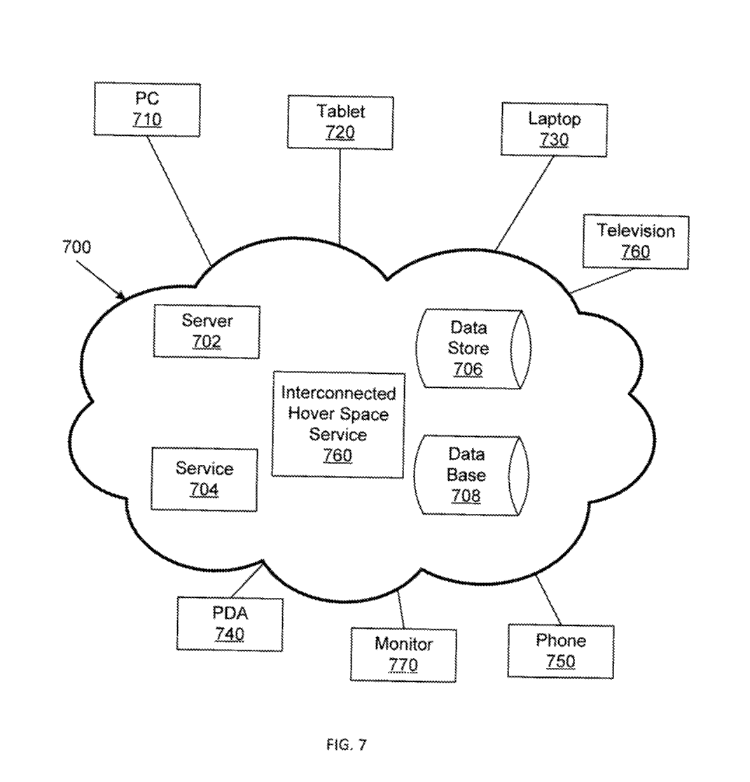

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi. 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example interconnected hover space service 760 residing in the cloud 700. The interconnected hover space service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud 700 and may, therefore, be used by the interconnected hover space service 760.

FIG. 7 illustrates various devices accessing the interconnected hover space service 760 in the cloud 700. The devices include a computer 710, a tablet 720, a laptop computer 730, a desktop monitor 770, a television 760, a personal digital assistant 740, and a mobile device (e.g., cellular phone, satellite phone) 750. It is possible that different users at different locations using different devices may access the interconnected hover space service 760 through different networks or interfaces. In one example, the interconnected hover space service 760 may be accessed by a mobile device 750. In another example, portions of interconnected hover space service 760 may reside on a mobile device 750. Interconnected hover space service 760 may perform actions including, for example, identifying devices that may be affected by a hover action on one device, sending control actions generated by a hover event at a hover-sensitive device to another device, identifying devices for which a shared display may be created, managing a shared display, identifying devices for which a shared hover space is to be created, identifying hover actions that span a shared hover space, or other service. In one embodiment, interconnected hover space service 760 may perform portions of methods described herein (e.g., method 500, method 600).

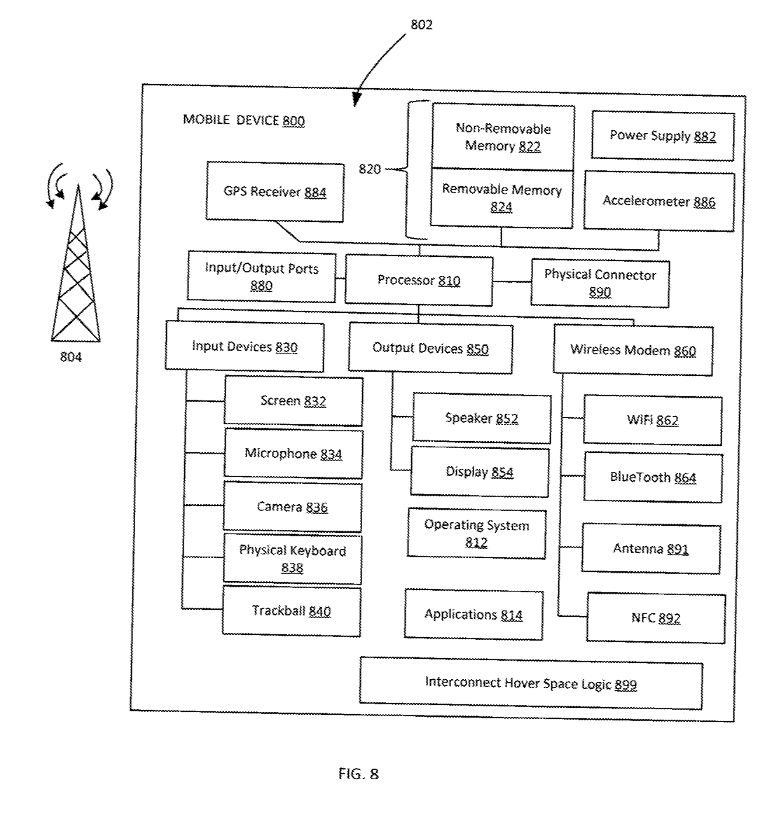

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), etc.) and may allow wireless two-way communications with one or more mobile communications networks 804, such as a cellular or satellite networks.

Mobile device 800 can include a controller or processor 810 (e.g., signal processor, microprocessor, application specific integrated circuit (ASIC), or other control and processing logic circuitry) for performing tasks including touch detection, hover detection, signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), video games, movie players, television players, productivity applications, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include hover action data, shared hover space data, shared display data, user interface element state, cursor data, hover control data, hover action data, control event data, web pages, text, images, sound files, video data, or other data sets. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a screen 832 that is hover-sensitive, a microphone 834, a camera 836, a physical keyboard 838, or trackball 840. The mobile device 800 may also support output devices 850 including, but not limited to, a speaker 852 and a display 854. Display 854 may be incorporated into a hover-sensitive i/o interface. Other possible input devices (not shown) include accelerometers (e.g., one dimensional, two dimensional, three dimensional). Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting hover gestures that may affect more than a single device.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices that have displays whose content or control elements may be controlled, at least in part, by interconnect hover space logic 899. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global System for Mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include an interconnect hover space logic 899 that provides a functionality for the mobile device 800 and for controlling content or controls displayed on another device with which mobile device 800 is interacting. For example, interconnect hover space logic 899 may provide a client for interacting with a service (e.g., service 760, FIG. 7), Portions of the example methods described herein may be performed by interconnect hover space logic 899. Similarly, interconnect hover space logic 899 may implement portions of apparatus described herein.

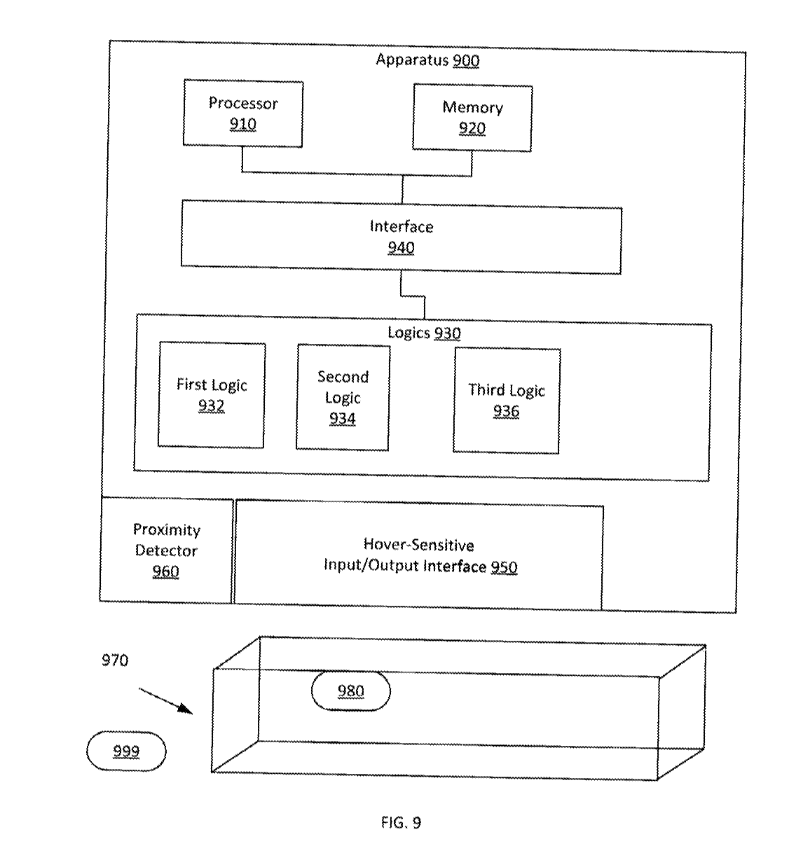

FIG. 9 illustrates an apparatus 900 that facilitates processing hover interactions across interconnected devices. In one example, the apparatus 900 includes an interface 940 that connects a processor 910, a memory 920, a set of logics 930, a proximity detector 960, and a hover-sensitive i/o interface 950. The set of logics 930 may control the apparatus 900 and may also control another device(s) or hover sensitive device(s) in response to a hover gesture performed in a hover space 970 associated with the input/output interface 950. In one embodiment, the proximity detector 960 may include a set of capacitive sensing nodes that provide hover-sensitivity for the input/output interface 950. Elements of the apparatus 900 may be configured to communicate with each other, but not all connections have been shown for clarity of illustration.

The proximity detector 960 may detect an object 980 in a hover space 970 associated with the apparatus 900. The hover space 970 may be, for example, a three dimensional volume disposed in proximity to the i/o interface 950 and in an area accessible to the proximity detector 960. The hover space 970 has finite bounds. Therefore the proximity detector 960 may not detect an object 999 that is positioned outside the hover space 970.

Apparatus 900 may include a first logic 932 that establishes a context for an interaction between the apparatus 900 and another hover-sensitive device or devices. The context may control, at least in part, how the apparatus 900 will interact with other hover sensitive devices. The first logic 932 may establish the context in different ways. For example, the first logic 932 may establish the context as a directional context or a directionless context. A directional context may rely on gestures that are directed toward a specific device whose relative geographic position is known. A directionless context may rely on gestures that affect interconnected devices regardless of their position. The first logic 932 may also establish the context as a shared display context or an individual display context. A shared display context may allow multiple devices to present a single integrated display that is larger than any of the individual displays. This may enhance game play, image viewing, or other applications. The first logic 932 may also establish the context as a one-to-one context or a one-to-many context. A one-to-one context may allow apparatus 900 to interact with one other specific device while a one-to-many context may allow apparatus 900 to interact with multiple other devices.

Apparatus 900 may include a second logic 934 that detects a hover event in the hover space and produces a control event based on the hover event. The hover event may be, for example, a hover lift event, a hover move event, a hover release event, a hover send event, a hover distribute event, or other event. A hover lift event may virtually lift an item from a display on apparatus 900. A hover crane event is an example of a hover lift event. A hover move event may be generated when a user moves their finger or fingers in the hover space. A hover send event may be generated in response to, for example, a flick gesture. A hover send event may cause content found on apparatus 900 to be sent to another apparatus. A hover distribute event may be generated in response to, for example, a poof gesture. A hover distribute event may cause content to be sent to multiple devices.

The hover action and the hover event may be associated with a specific item on the apparatus 900. The item with which the hover action or event is associated may be displayed on apparatus 900. For example, an icon representing a file may be displayed on apparatus 900 or a game piece (e.g., checker) may be displayed on a game board presented by apparatus 900. The second logic 934 may selectively assign an item (e.g., file, game piece, image) associated with the apparatus 900 to the hover event.

Apparatus 900 may include a third logic 936 that controls the apparatus and another device or devices based on the control event. The control event may cause the apparatus 900 to send the item (e.g., file, image) to another device or devices. The control event may also cause the apparatus 900 to make the item (e.g., checker) appear to move from apparatus 900 to another apparatus or just to move on apparatus 900. In one embodiment, the control event may cause the apparatus 900 and another member of the plurality of devices to present an integrated display. The integrated display may be, for example, a game board (e.g., checkerboard, chess board), a map, an image, or other displayable item. For example, two users may have each had a small representation of a map on their phones, but when the devices were pushed together and a user made a “connect” gesture over the two devices, the map may have been enlarged and displayed on both phones. The connect gesture may be, for example, a pinch gesture that begins with one finger over each of the displays and ends with the two fingers pinched together near the intersection point of the two phones. In one embodiment, the control event may change what is displayed on the integrated display. For example, the control event may cause a checker to be picked up from one display and placed on another display.

In one embodiment, apparatus 900 may include a fourth logic that coordinates control events from multiple devices. Coordination may be required because different users may be performing different hover actions or different hover gestures on different apparatus at or near the same time. For example, in an air hockey application that uses two phones, both players may be moving their fingers above their screens at substantially the same time and apparatus 900 may need to coordinate the events generated by the simultaneous movements to present a seamless game experience that accounts for actions by both players.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store user interface state information, characterization data, object data, data about a shared display, data about a shared hover space, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions.

In one embodiment, the apparatus 900 may be a general purpose computer that has been transformed into a special purpose computer through the inclusion of the set of logics 930. Apparatus 900 may interact with other apparatus, processes, and services through, for example, a computer network.

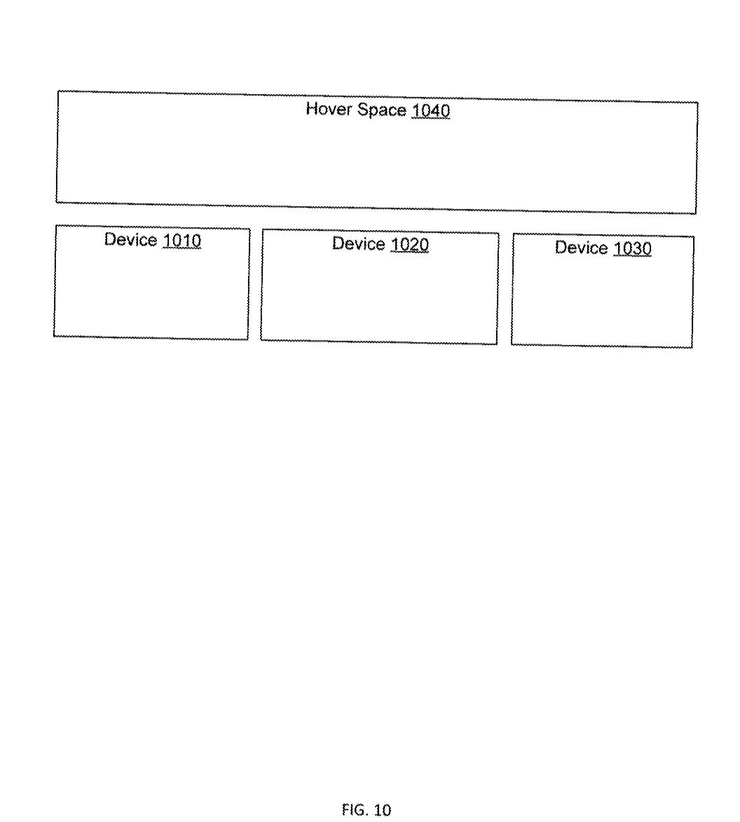

FIG. 10 illustrates hover-sensitive devices using a shared hover-space 1040 to support hover interactions that span interconnected devices. A first device 1010, a second device 1020, and a third device 1030 may be positioned close enough together so that a shared hover space 1040 may be created. When the shared hover space 1040 is present, a hover action may begin in a first location (e.g., first device 1010), may be detected as it leaves the first location and enters a second location (e.g., second device 1020), may be detected as it transits and leaves the second location, and may be detected as it terminates at a third location (e.g., third device 1030). While three devices are illustrated sharing the hover space 1040, a greater or lesser number of devices may create or use a shared hover space.

FIG. 11 illustrates a time sequence where two devices come together to create a larger shared display over which hover actions can be performed. At time T1, a first device 1110 and a second device 1120 are positioned far enough apart that providing a shared display is impractical. Even though device 1110 and device 1120 are spaced apart, a hover gesture on device 1110 could still be used to control device 1120. For example, an object could be picked up on device 1110 and tossed to device 1120. Tossing the object may, for example, copy or move content.

At time T2, the first device 1110 and the second device 1120 have been moved close enough together that providing a shared display is now practical. For example, two colleagues may have pushed their tablet computers together on a conference table. While the proximity of the two devices may allow a shared display to be provided, the shared display may not be provided unless there is a context in which it is appropriate to provide the shared display. An appropriate context may exist when, for example, the two users are both editing the same document, when the two users want to look at the same image, when the two users are playing a game together, or in other situations.

At time T3, the letters ABC, which represent a shared image, are displayed across a shared display associated with device 1110 and device 1120. If the two users are sitting beside each other, then the image may be displayed so that both users can see the image from the same point of view at the same time. But if the two users are seated across the table from each other, then the two users may want to take turns looking at the shared image. Thus, a hover gesture 1130 may be employed to identify the direction in which the shared image is to be displayed. The hover gesture 1130 may begin on one display and end on another display to indicate the direction of the image. While two devices are illustrated, a greater number of devices and devices of different types may be employed.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “Only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
establishing a relationship between a first apparatus and a second apparatus, where the first apparatus is a hover-sensitive apparatus having a first hover space provided by the first apparatus;
identifying a hover action performed in the first hover space; and
controlling the second apparatus based, at least in part, on the hover action.

2. The method of claim 1,
where establishing the relationship includes identifying relative or absolute geographic positions for the first apparatus and the second apparatus and storing data describing the relative or absolute geographic positions, and
where controlling the second apparatus depends, at least in part, on the data describing the relative or absolute geographic positions.

3. The method of claim 1,
where establishing the relationship includes establishing a shared display between the first apparatus and the second apparatus, and
where controlling the second apparatus includes coordinating the presentation of information on the shared display.

4. The method of claim 1,
where the second apparatus is a hover-sensitive apparatus having a second hover space provided by the second apparatus;
where establishing the relationship includes establishing a shared hover space for the first apparatus and the second apparatus, where the shared hover space includes a portion of the first hover space and a portion of the second hover space, where establishing the relationship includes determining how to coordinate concurrent actions performed in the first hover space and the second hover space, and
where the method includes:
identifying a shared hover action performed in the first hover space or in the second hover space;
establishing a time limit for completion of the hover action or the shared hover action, and
controlling the first apparatus and the second apparatus based, at least in part, on the shared hover action.

5. The method of claim 1,
where establishing the relationship includes identifying content that may be shared between the first apparatus and the second apparatus;
where the hover action is a crane gesture, and
where controlling the second apparatus includes selectively providing content from the first apparatus to the second apparatus, where the content is selected based, at least in part, by the crane gesture.

6. The method of claim 1,
where the hover action is a crane gesture, and
where the method includes manipulating a user interface displayed on the first apparatus or on the second apparatus based, at least in part, on a user interface element associated with the crane gesture.

7. The method of claim 3,
where the hover action is a crane gesture, and
where the method includes manipulating a user interface displayed on the shared display based, at least in part, on a user interface element associated with the crane gesture.

8. The method of claim 1,
where the hover action begins and ends in the first hover space.

9. The method of claim 4,
where the hover action begins in the first hover space and ends in the second hover space.

10. The method of claim 1,
where the hover action is a directionless gesture, and
where controlling the second apparatus includes providing content from the first apparatus to the second apparatus, where the content is selected, at least in part, by the directionless gesture.

11. The method of claim 2,
where the hover action has an associated direction, and
where controlling the second apparatus depends, at least in part, on the associated direction and the relative or absolute geographic positions.

12. The method of claim 2,
where the hover action is a flick gesture, and
where controlling the second apparatus depends, at least in part, on the direction or speed of the flick gesture, and on the relative or absolute geographic positions.

13. A computer-readable storage medium storing computer-executable instructions that when executed by a computer cause the computer to perform a method, the method comprising:
establishing a relationship between a first apparatus and a second apparatus, where the first apparatus is a hover-sensitive apparatus having a first hover space provided by the first apparatus and where the second apparatus is a hover-sensitive apparatus having a second hover space provided by the second apparatus,
where establishing the relationship includes identifying relative or absolute geographic positions for the first apparatus and the second apparatus and storing data describing the relative or absolute geographic positions,
where establishing the relationship includes establishing a shared hover space for the first apparatus and the second apparatus, where the shared hover space includes a portion of the first hover space and a portion of the second hover space, and
where establishing the relationship includes establishing a shared display between the first apparatus and the second apparatus,
identifying a hover action performed in the first hover space;
controlling the second apparatus based, at least in part, on the hover action, and
identifying a shared hover action performed in the first hover space or in the second hover space and controlling the first apparatus and the second apparatus based, at least in part, on the shared hover action,
where the hover action is a crane gesture and where the method includes:
providing content from the first apparatus to the second apparatus, where the content is selected based, at least in part, by the crane gesture,
manipulating a user interface displayed on the first apparatus or on the second apparatus based, at least in part, on a user interface element associated with the crane gesture, or
manipulating a user interface displayed on the shared display based, at least in part, on a user interface element associated with the crane gesture,
where the hover action is a flick gesture and where controlling the second apparatus depends, at least in part, on the direction or speed of the flick gesture and on the relative geographic positions,
where the hover action is a directionless gesture and where controlling the second apparatus includes copying or moving content from the first apparatus to the second apparatus, where the content is selected, at least in part, by the directionless gesture, or
where the hover action has an associated direction and where controlling the second apparatus depends, at least in part, on the associated direction and the relative geographic positions,
where controlling the second apparatus depends, at least in part, on the data describing the relative or absolute geographic positions, and
where controlling the second apparatus includes coordinating the presentation of information on the shared display.

14. An apparatus, comprising:
a processor;
a memory;
an input/output interface that is hover-sensitive;
a set of logics that control the apparatus and one or more hover sensitive devices in response to a hover gesture performed in a hover space associated with the input/output interface, and
an interface to connect the processor, the memory, and the set of logics,
the set of logics comprising:
a first logic that establishes a context for an interaction between the apparatus and the one or more hover sensitive devices, where the context controls, at least in part, how the apparatus will interact with the one or more hover sensitive devices;
a second logic that detects a hover event in the hover space and produces a control event based on the hover event; and
a third logic that controls the apparatus and the one or more hover sensitive devices based on the control event.

15. The apparatus of claim 14,
where the first logic establishes the context as a directional context or a directionless context,
where the first logic establishes the context as a shared display context or an individual display context, and
where the first logic establishes the context as a one-to-one context or a one-to-many context.

16. The apparatus of claim 15,
where the hover event is a hover lift event, a hover move event, a hover release event, a hover send event, or a hover distribute event, and
where the second logic selectively assigns an item associated with the apparatus to the hover event.

17. The apparatus of claim 16, where the control event causes the apparatus to provide the item to the one or more devices.

18. The apparatus of claim 16, where the control event causes the apparatus and the one or more devices to present an integrated display.

19. The apparatus of claim 18, where the control event changes ha is displayed on the integrated display.

20. The apparatus of claim 16, comprising a fourth logic that coordinates control events from the apparatus and the one or more hover sensitive devices.
